(19) United States
(12) Patent Application Publication
(10) Pub. No.: US 2015/0253783 A1
(43) Pub. Date: Sep. 10, 2015

(54) PRESSURE REDUCING VALVE AND PRESSURE REGULATING DEVICE

(71) Applicant: AISAN KOGYO KABUSHIKI KAISHA, Obu-shi (JP)

(72) Inventors: Katsuyuki HATA, Nagoya-shi (JP); Masahiro KOBAYASHI, Toyohashi-shi (JP)

(21) Appl. No.: 14/638,738

(22) Filed: Mar. 4, 2015

(30) Foreign Application Priority Data
Mar. 7, 2014 (JP) 2014-045207

(51) Int. Cl. G05D 7/06; F16K 31/00; F16K 7/12

(52) U.S. Cl. CPC G05D 7/0647; F16K 7/12; F16K 31/005

(57) ABSTRACT

A pressure reducing valve includes a diaphragm substrate, a piezo-electric device, and a valve seat. The diaphragm substrate is arranged in a pressure regulating chamber into which CNG flows through an inflow passage. When the piezo-electric device is driven, the diaphragm substrate is deformed. The diaphragm substrate is seated on the valve seat. A portion of the valve seat that faces the diaphragm substrate is formed of an elastic material, and has elastic force greater than that of the diaphragm substrate.

### BACKGROUND OF THE INVENTION

The present invention relates to a pressure reducing valve and a pressure regulating device.

Japanese Laid-Open Patent Publication No. 62-224780 discloses a pressure reducing valve equipped with a piezo-electric device as an actuator. The pressure reducing valve includes a valve body arranged in a pressure regulating chamber, and a valve seat on which the valve body is seated. The valve body includes a diaphragm substrate and an elastic body. The elastic body is attached to a surface of the diaphragm substrate that faces the valve seat. The piezo-electric device is attached to a surface on a side of the diaphragm substrate that is opposite to the valve seat. A spring that urges the valve body against the valve seat is arranged in the pressure regulating chamber. The spring is arranged on a side of the valve body that is opposite to the valve seat.

In the above pressure reducing valve, while no voltage is applied to the piezo-electric device, the elastic body of the valve body is urged by the spring to be pressed against the valve seat. This prevents a fluid from flowing from the pressure regulating chamber to a downstream. Meanwhile, when voltage is applied to the piezo-electric device, the piezo-electric device is driven to deform the valve body, thereby generating a gap between the valve body and the valve seat. Consequently, the fluid having flowed from an inflow passage into the pressure regulating chamber flows out to an outflow passage.

Recently, reduction of power consumption has been demanded on pressure reducing valves that valve bodies are deformed through driving of actuators.

### SUMMARY OF THE INVENTION

An object of the present invention is to provide a pressure reducing valve and a pressure regulating device capable of reducing power consumption required for deforming a valve body through driving of an actuator.

In order to solve the above problem, according to a first aspect of the present invention, provided is a pressure reducing valve including: a pressure regulating chamber; a valve body arranged in the pressure regulating chamber; an actuator that deforms the valve body; and a valve seat on which the valve body is seated. An inflow passage through which a fluid flows into the pressure regulating chamber, and an outflow passage to which the fluid flows out from the pressure regulating chamber are in communication with the pressure regulating chamber. The pressure reducing valve is configured such that a gap is formed between the valve body and the valve seat when the valve body is deformed through driving of the actuator to allow the fluid in the pressure regulating chamber to flow out to the outflow passage. A portion of the valve seat that faces the valve body is formed of an elastic material, and has a greater elastic force than that of the valve body.

In order to solve the above problem, according to a second aspect of the present invention, provided is a pressure regulating device including: a housing chamber; and a downstream passage opening toward the housing chamber, pressure regulating device regulating outflow rate of a fluid, which has flowed in the housing chamber, flowing out through the downstream passage. The pressure regulating device includes a valve sliding in the housing chamber along a peripheral wall of the housing chamber. The housing chamber is partitioned by the valve into a first room in communication with the downstream passage and a second room out of communication with the downstream passage. A first upstream passage that introduces the fluid into the first room is in communication with the first room, and a second upstream passage that introduces the fluid into the second room is in communication with the second room. An orifice is arranged in the second upstream passage, and an inflow passage that introduces the fluid in the second room into the aforementioned pressure reducing valve for regulation is connected to the second room.

### BRIEF DESCRIPTION OF THE DRAWINGS

FIG. 1 is a schematic structural view showing a fuel supply system equipped with a pressure regulating device of the present invention and an internal combustion engine;

FIG. 2 is a sectional view showing a schematic structure of the pressure regulating device;

FIG. 3 is a partial sectional view showing a state in which a pressure reducing valve of the pressure regulating device is opened;

FIG. 4 is a schematic view showing operation of the pressure regulating device;

FIG. 5 is a partial sectional view showing the pressure regulating device in another example; and

FIG. 6 is a sectional view showing a schematic structure of the pressure regulating device in another example.

### DETAILED DESCRIPTION OF THE PREFERRED EMBODIMENTS

Hereinafter, one embodiment in which a pressure regulating device of the present invention is embodied will be described with reference to FIG. 1 to FIG. 4.

FIG. 1 shows an internal combustion engine 11 operated by use of a gaseous fuel as a fluid, specifically, CNG (compressed natural gas). As shown in FIG. 1, the internal combustion engine 11 includes an intake passage 12, and a fuel supply system 20 that supplies the CNG. A throttle valve 13 and a fuel injection valve 14 are attached to the intake passage 12. Opening of the throttle valve 13 is controlled through operation on an accelerator by a driver. The fuel injection valve 14 injects the CNG supplied from the fuel supply system 20. A gaseous mixture containing an intake gas passing through the throttle valve 13 and the CNG injected from the fuel injection valve 14 are burned in a combustion chamber 16 of a cylinder 15. This combustion causes reciprocating movement of a piston 17, thereby rotating a crankshaft that is an output shaft of the internal combustion engine 11 in a predetermined direction.

The fuel supply system 20 includes a CNG tank 21 for reserving high-pressure CNG, a high-pressure fuel line 22 connected to the CNG tank 21, and a pressure sensor 25. The CNG flows through the high-pressure fuel line 22, and the pressure thereof is reduced by a pressure regulating device 23, and is then supplied to a delivery pipe 24. The CNG is supplied from the delivery pipe 24 to the fuel injection valve 14, and is injected from the fuel injection valve 14 to the intake passage 12. The pressure sensor 25 detects fuel pressure in the delivery pipe 24 that is fluid pressure in the downstream from the pressure regulating device 23. The fuel pressure detected by the pressure sensor 25 is input to a controller (not shown). The controller controls the pressure regulating device 23 to regulate the fuel pressure in the delivery pipe 24.

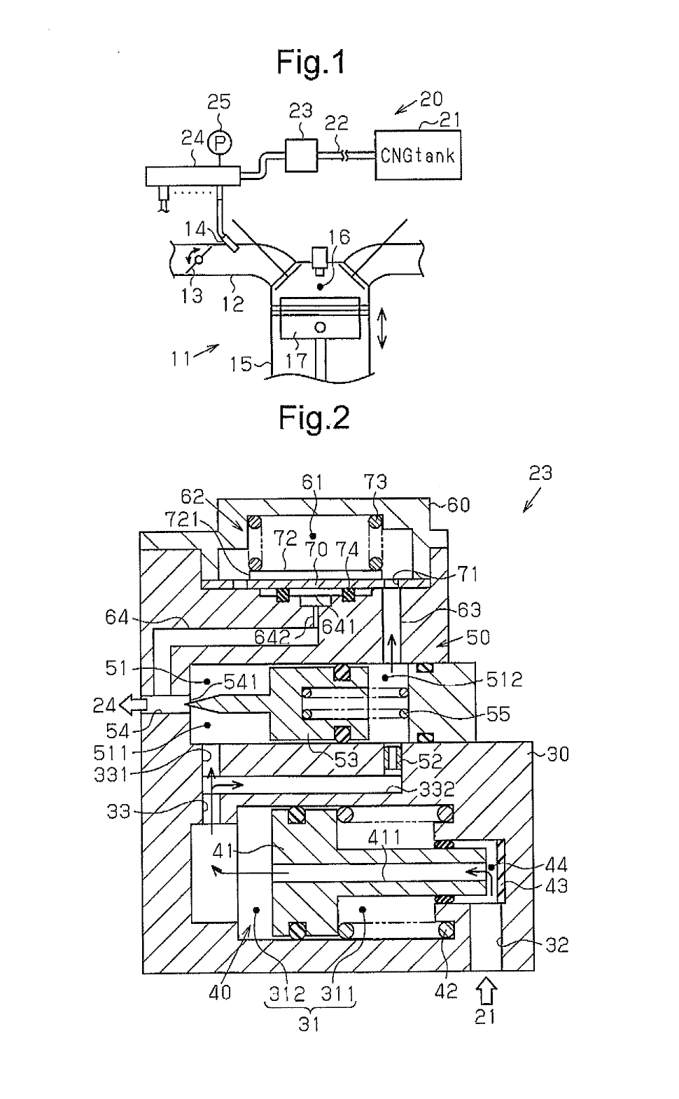

As shown in FIG. 2, the pressure regulating device 23 includes a first pressure reducing mechanism 40 and a second pressure reducing mechanism 50. The first pressure reducing mechanism 40 reduces pressure of the high-pressure CNG supplied from the CNG tank 21 into a main body 30 to a specified pressure. The second pressure reducing mechanism 50 performs fine regulation of the fuel pressure in the delivery pipe 24. The first pressure reducing mechanism 40 is a pressure reducing valve for high pressure that reduces pressure of the high-pressure CNG externally supplied.

In the main body 30, there are arranged a high-pressure fluid passage 32, a pressure reducing chamber 31 in communication with the high-pressure fluid passage 32, a supply passage 33 in communication with the pressure reducing chamber 31, and a housing chamber 51. The high-pressure fluid passage 32 is supplied with the high-pressure CNG from the CNG tank 21. The first pressure reducing mechanism 40 is arranged in the pressure reducing chamber 31. The pressure of the CNG is reduced by the first pressure reducing mechanism 40 in the pressure reducing chamber 31, and is then introduced through the supply passage 33 into the second pressure reducing mechanism 50.

The first pressure reducing mechanism 40 includes a piston 41 and a first spring 42. The piston 41 slides in the pressure reducing chamber 31 in the axial direction of the piston 41. A communicating passage 411 extending in the axial direction of the piston 41 is formed inside the piston 41. The communicating passage 411 opens at both axial ends of the piston 41.

The pressure reducing chamber 31 is partitioned into a first room 311 of a space located rightward of the piston 41, and a second room 312 of a space located leftward of the piston 41 in FIG. 2. The first room 311 is in communication with the high-pressure fluid passage 32, but out of communication with the supply passage 33. The second room 312 is out of communication with the high-pressure fluid passage 32, but in communication with the supply passage 33. Sliding movement of the piston 41 in its axial direction changes the volume of the first room 311 and the volume of the second room 312, respectively.

The first spring 42 urges the piston 41 in the direction of decreasing the volume of the second room 312, that is, leftward in FIG. 2. If the pressure of the CNG (fluid pressure) in the second room 312 becomes higher, the piston 41 slides rightward, that is, in the direction of increasing the volume of the second room 312 against urging force of the first spring 42. When the right end of the piston 41 comes into contact with a seal member 43 as the valve seat, the aperture of the communicating passage 411 in the piston 41 is sealed by the seal member 43. This prevents the CNG from flowing from the first room 311 into the second room 312.

In this state, if the CNG in the second room 312 flows toward the second pressure reducing mechanism 50, the pressure of the CNG in the second room 312 becomes reduced. At this time, the piston 41 is urged by the first spring 42, and slides leftward. The piston 41 comes out of contact with the seal member 43, and the aperture of the communicating passage 411 is released. Accordingly, the CNG in the first room 311 starts to flow through the communicating passage 411 into the second room 312. In this state, as the pressure of the CNG in the second room 312 is lower, and a gap 44 between the piston 41 and the seal member 43 is greater, the flow rate of the CNG flowing from the first pressure reducing mechanism 40 to the second pressure reducing mechanism 50 becomes increased. In this way, the position of the piston 41 in its axial direction in the pressure reducing chamber 31 is automatically adjusted to maintain the pressure of the CNG in the second room 312 at around a specified pressure, and supply the CNG at substantially the specified pressure through the supply passage 33 to the second pressure reducing mechanism 50.

The pressure of the CNG is reduced by the first pressure reducing mechanism 40, then the CNG flows through the supply passage 33 into the housing chamber 51. The supply passage 33 branches into two passages 331, 332 in the downstream. The first upstream passage 331 is connected to the vicinity of a left end of the housing chamber 51. The second upstream passage 332 is connected to the vicinity of a right end of the housing chamber 51. An orifice 52 is arranged in the second upstream passage 332 to decrease a sectional area of this passage.

In the housing chamber 51, there are arranged a valve 53, and a second spring 55 as an urging member for the valve. The valve 53 slides along a peripheral wall of the housing chamber 51 in the axial direction of the valve 53. The housing chamber 51 is partitioned by the valve 53 into a first room 511 located leftward of the valve 53, and a second room 512 located rightward of the valve 53. Sliding movement of the valve 53 in its axial direction changes the volume of the room 511 and the volume of the room 512, respectively.

The first room 511 is in communication with the first upstream passage 331, but out of communication with the second upstream passage 332. The second room 512 is in communication with the second upstream passage 332, but out of communication with the first upstream passage 331. The first room 511 is in communication with a downstream passage 54 to introduce the CNG into the delivery pipe 24.

An aperture 541 that provides communication between the downstream passage 54 and the housing chamber 51 is formed in the wall surface on the left of the housing chamber 51. The aperture 541 can be sealed by the valve 53. Sliding movement of the valve 53 in the direction of decreasing the volume of the first room 511, that is, leftward in FIG. 2 brings the aperture 541 to be sealed by the valve 53. Even if the aperture 541 is in a state of being sealed by the valve 53, communication is still maintained between the first room 511 of the housing chamber 51 and the first upstream passage 331.

From the above state, if the valve 53 slides rightward, that is, in the direction of increasing the volume of the first room 511, the aperture 541 is released. This brings the CNG in the first room 511 of the housing chamber 51 to flow through the aperture 541 into the downstream passage 54. At the same time, the CNG in the pressure reducing chamber 31 flows through the first upstream passage 331 into the first room 511. At this time, the position of the valve 53 in its axial direction in the housing chamber 51 is adjusted to adjust the opening of the aperture 541. Consequently, the outflow rate of the CNG flowing to the downstream passage 54 is regulated, and the fuel pressure in the delivery pipe 24 is regulated as well.

The second spring 55 urges the valve 53 to the left. A cover member 60 is attached to an upper portion of the main body 30. A pressure regulating chamber 61 is formed by the main body 30 and the cover member 60. A pressure reducing valve 62 as a pressure reducing valve for regulation is arranged in the pressure regulating chamber 61. An inflow passage 63 and an outflow passage 64 both in communication with the pressure regulating chamber 61 are formed in the main body 30. The CNG in the second room 512 of the housing chamber 51 is introduced through the inflow passage 63 into the pressure regulating chamber 61. The CNG in the pressure regulating chamber 61 is introduced through the outflow passage 64 into the downstream passage 54. The inflow passage 63 is connected to the vicinity of an end portion of the pressure regulating chamber 61. The outflow passage 64 is connected to a center portion of the pressure regulating chamber 61. An aperture 641 that provides communication between the outflow passage 64 and the pressure regulating chamber 61 is formed in the lower surface of the pressure regulating chamber 61. When the aperture 641 is sealed by the pressure reducing valve 62, no CNG flows from the pressure regulating chamber 61 to the outflow passage 64. When the aperture 641 is released by the pressure reducing valve 62, the CNG flows through the inflow passage 63 into the pressure regulating chamber 61, then flows through the outflow passage 64 to the downstream passage 54.

On the way of the outflow passage 64, a small-diameter portion 642 having a small passage sectional area is formed. The small-diameter portion 642 is formed between the aperture 641 and the downstream passage 54. The outflow rate of the CNG flowing out from the pressure regulating chamber 61 is regulated through the small-diameter portion 642.

The pressure reducing valve 62 includes a diaphragm substrate 70 as a valve body. The diaphragm substrate 70 is formed by a single plate member of a metallic or ceramic material. A through hole 71 is formed in the diaphragm substrate 70. The CNG flows from the inflow passage 63 into the pressure regulating chamber 61, through the through hole 71, and then is introduced to the back surface of the diaphragm substrate 70, that is, the vicinity of the upper surface of the diaphragm substrate 70.

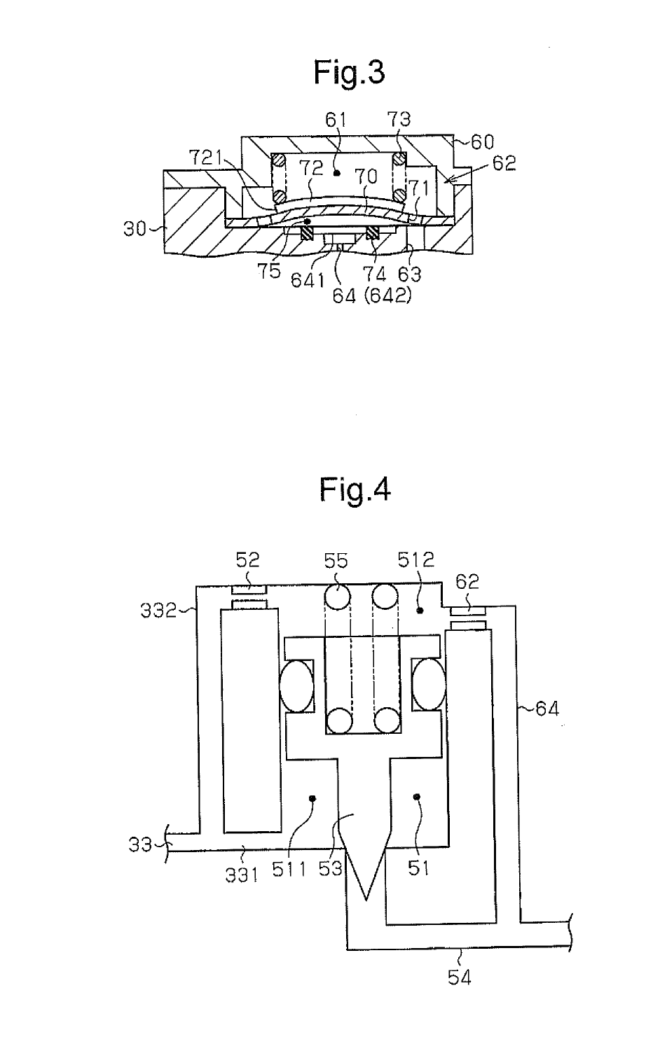

A piezo-electric device 72 as an actuator is attached to the upper surface of the diaphragm substrate 70 to deform the diaphragm substrate 70. The piezo-electric device 72 is formed in a substantially discoid shape. The piezo-electric device 72 has a diameter greater than that of the aperture 641. As shown in FIG. 2 and FIG. 3, when electric power is supplied to the piezo-electric device 72, the piezo-electric device 72 is driven to deform the diaphragm substrate 70. At this time, the center portion of the diaphragm substrate 70 is displaced upward. The displacement at the edge portion of the diaphragm substrate 70 is restricted by the cover member 60.

In the pressure regulating chamber 61, there is arranged a third spring 73 as an urging member. The third spring 73 urges the diaphragm substrate 70 downward. The third spring 73 is in contact with an edge portion 721 of the piezo-electric device 72 attached onto the diaphragm substrate 70. Urging force of the third spring 73 is applied to the diaphragm substrate 70 via the piezo-electric device 72.

The pressure reducing valve 62 includes a valve seat 74 formed of an elastic material. The valve seat 74 has greater elasticity than that of the material of the diaphragm substrate 70. The valve seat 74 is formed in an annular shape. The valve seat 74 has an inner diameter greater than the diameter of the aperture 641. The outer diameter of the valve seat 74 is smaller than the diameter of the piezo-electric device 72. A lower end of the third spring 73 is located radially outward of a contact portion between the diaphragm substrate 70 and the valve seat 74. The urging force of the third spring 73 is applied to the diaphragm substrate 70 from the lower end of the third spring 73.

While the piezo-electric device 72 is out of operation, the diaphragm substrate 70 is pressed against the valve seat 74 through the urging force of the third spring 73. Hence, the outflow passage 64 is sealed, thereby preventing the CNG from flowing from the pressure regulating chamber 61 into the outflow passage 64. While the piezo-electric device 72 is in operation, the diaphragm substrate 70 is deformed, thereby generating a gap 75 between the diaphragm substrate 70 and the valve seat 74. Consequently, the CNG flows out from the pressure regulating chamber 61 through the gap 75 into the outflow passage 64.

The pressure of the CNG in the pressure regulating chamber 61 varies with time. In a state of supplying constant electric power to the piezo-electric device 72, the diaphragm substrate 70 becomes harder to be deformed as the pressure of the CNG in the pressure regulating chamber 61 is higher. Specifically, as the pressure of the CNG in the pressure regulating chamber 61 is higher, the gap 75 between the diaphragm substrate 70 and the valve seat 74 that is formed by deformation of the diaphragm substrate 70 is more likely to become smaller. If the area of this gap 75 is smaller than the passage sectional area of the small-diameter portion 642, flow resistance of the CNG passing through the gap 75 is greater than flow resistance of the CNG passing through the small-diameter portion 642. Consequently, as the pressure of the CNG in the pressure regulating chamber 61 is higher, the outflow rate of the CNG flowing from the pressure regulating chamber 61 into the outflow passage 64 becomes smaller. This means that, during driving of the piezo-electric device 72, the outflow rate of the CNG flowing from the pressure regulating chamber 61 into the outflow passage 64 varies depending on the pressure of the CNG in the pressure regulating chamber 61.

As described above, the outflow rate of the CNG from the pressure regulating chamber 61 into the outflow passage 64 is easily subjected to influences of the pressure of the CNG in the pressure regulating chamber 61. This may cause deterioration of controllability in the fuel pressure in the delivery pipe 24 that is a fluid pressure in the downstream of the pressure regulating device 23. To counter this problem, in the present embodiment, the valve seat 74 has a dimension and a position that satisfy the following Condition 1.

(Condition 1) Even if the pressure of the CNG in the pressure regulating chamber 61 is equal to or greater than an expected maximum pressure, the area of the gap 75 between the valve seat 74 and the diaphragm substrate 70 deformed through driving of the piezo-electric device 72 is greater than the passage sectional area of the small-diameter portion 642 of the outflow passage 64.

In order to satisfy Condition 1, the inner diameter of the valve seat 74 is preferably set to be greater than a diameter of the small-diameter portion 642, and as great as possible. The valve seat 74 satisfying Condition 1 makes it hard to cause variation of the outflow rate of the CNG flowing from the pressure regulating chamber 61 into the outflow passage 64 even if the pressure of the CNG in the pressure regulating chamber 61 varies. This means that the outflow rate of the CNG flowing from the pressure regulating chamber 61 into the outflow passage 64 can be appropriately regulated by setting the dimension of the small-diameter portion 642.

Hereinafter, the operation of the aforementioned pressure regulating device 23 will be described with reference to FIG. 2 to FIG. 4.

As shown in FIG. 2, at the time of starting up the engine, the high-pressure CNG is started to be supplied from the CNG tank 21 to the pressure regulating device 23 with the pressure reducing valve 62 closed. The high-pressure CNG then flows into the pressure reducing chamber 31 of the main body 30, and the pressure thereof is reduced to the specified pressure by the first pressure reducing mechanism 40. After the pressure reduction, the CNG is introduced into the supply passage 33. Consequently, the pressure of the CNG in the second room 312 in the pressure reducing chamber 31 and the pressure of the CNG in the supply passage 33 both become higher.

Because the pressure reducing valve 62 is closed in this state, the pressure of the CNG in the first room 511 and the pressure of the CNG in the second room 512 in the housing chamber 51 both become higher. In this case, a difference between the pressure in the first room 511 and the pressure in the second room 512 is small, and thus the valve 53 is urged by the second spring 55 to seal the aperture 541.

In this state, when electric power is supplied to the piezo-electric device 72 of the pressure reducing valve 62, the piezo-electric device 72 is driven to deform the diaphragm substrate 70 as shown in FIG. 3. This deformation brings the pressure reducing valve 62 to open, and the CNG in the second room 512 of the housing chamber 51 starts to flow into the pressure regulating chamber 61. The CNG flows into the pressure regulating chamber 61, and thereafter flows out to the outflow passage 64. Subsequently, the CNG flows through the downstream passage 54, and is supplied into the delivery pipe 24.

Once the CNG starts to flow into the pressure regulating chamber 61 in the above manner, the pressure of the CNG in the second room 512 becomes decreased. Then, the pressure of the CNG in the first room 511 becomes sufficiently higher than the pressure of the CNG in the second room 512 in the housing chamber 51. Accordingly, against urging force of the second spring 55, the valve 53 slides in the direction of increasing the volume of the first room 511, that is, upward in FIG. 4. As a result, the aperture 541 is released, and thus the CNG flows out from the first room 511 of the housing chamber 51 to the downstream passage 54, and then is supplied into the delivery pipe 24.

The second upstream passage 332 is in communication with the second room 512 of the housing chamber 51, and the orifice 52 is arranged in the second upstream passage 332. In this configuration, while the pressure reducing valve 62 is opened, the flow rate of the CNG flowing from the first pressure reducing mechanism 40 into the first room 511 of the housing chamber 51 is greater than the flow rate of the CNG flowing from the first pressure reducing mechanism 40 into the second room 512 of the housing chamber 51. Hence, while the pressure reducing valve 62 is opened, the open state of the aperture 541 is maintained. In this way, having a passage for supplying the CNG to the delivery pipe 24 without interruption by the pressure reducing valve 62 enables rapid increase in fuel pressure in the delivery pipe 24.

After the fuel pressure in the delivery pipe 24 is increased to the predetermined pressure, power supply to the piezo-electric device 72 is stopped, and then the pressure reducing valve 62 is closed. Hence, the CNG in the second room 512 of the housing chamber 51 is stopped to flow into the pressure regulating chamber 61, thereby increasing the pressure of the CNG in the second room 512. In the housing chamber 51, a difference in pressure between the second room 512 and the first room 511 becomes smaller, and the valve 53 is urged by the second spring 55, and slides leftward in FIG. 2. The aperture 541 is sealed by the valve 53, thereby maintaining the fuel pressure in the delivery pipe 24.

If the arrangement positions of the orifice 52 and the pressure reducing valve 62 are exchanged to each other, the difference in pressure between the second room 512 and the first room 511 does not become smaller even if the pressure reducing valve 62 is closed. In this case, the aperture 541 is not sealed by the valve 53, and the supply of the CNG to the delivery pipe 24 is maintained, and thus the fuel pressure in the delivery pipe 24 is unnecessarily increased. To the contrary, in the present embodiment, the pressure reducing valve 62 is closed to seal the aperture 541 by the valve 53. This configuration can securely stop the supply of the CNG to the delivery pipe 24, thereby suppressing increase in fuel pressure in the delivery pipe 24.

According to the present embodiment, the following advantageous effects can be attained.

(1) The valve seat 74 of the pressure reducing valve 62 is formed of an elastic material. In this configuration, a seal member is eliminated in the valve body deformed through driving of the piezo-electric device 72. Therefore, the valve body is reduced in weight, and a smaller force is required for deforming the valve body. Accordingly, it is possible to reduce power consumption required for deforming the valve body through driving of the piezo-electric device 72.

(2) Such a valve body is known that is formed by combining a seal member of an elastic material to the diaphragm substrate 70. In the valve body of this type, repetitive deformation through driving of the piezo-electric device 72 is likely to cause separation of the seal member from the diaphragm substrate 70, which might deteriorate controllability of the pressure reducing valve 62. To the contrary, in the present embodiment, no seal member is combined to the diaphragm substrate 70; thus the aforementioned problem due to deterioration over time of the valve body is prevented. Accordingly, durability of the pressure reducing valve 62 is enhanced.

(3) Even if the pressure of the CNG in the pressure regulating chamber 61 is higher, the area of the gap 75 between the valve seat 74 and the diaphragm substrate 70 deformed through driving of the piezo-electric device 72 is greater than the passage sectional area of the small-diameter portion 642 of the outflow passage 64. Hence, it is possible to suppress variation in accuracy of pressure reduction of the CNG performed by the pressure reducing valve 62, which is caused by change in pressure of the CNG in the pressure regulating chamber 61. Accordingly, it is possible to enhance accuracy of regulation of the fuel pressure in the delivery pipe 24.

(4) The lower end of the third spring 73 is located radially outward of the contact portion between the diaphragm substrate 70 and the valve seat 74. In this configuration, stress that hinders deformation of the diaphragm substrate 70 is hardly applied to a portion in the vicinity of the aperture 641 in the diaphragm substrate 70. Hence, the gap 75 between the diaphragm substrate 70 and the valve seat 74 can be formed even if a small driving force is applied from the piezo-electric device 72 to the diaphragm substrate 70. Accordingly, it is possible to reduce power consumption required for deforming the diaphragm substrate 70 through driving of the piezo-electric device 72.

(5) In the case of maintaining the fuel pressure in the delivery pipe 24 through the pressure regulating device 23, it is possible to seal the aperture 541 by the valve 53 by closing the pressure reducing valve 62. Through this configuration, it is possible to suppress outflow of the CNG from the pressure regulating device 23 into the delivery pipe 24, thereby appropriately maintaining the fuel pressure in the delivery pipe 24. On the other hand, when the pressure reducing valve 62 is opened, the pressure of the CNG in the second room 512 of the housing chamber 51 becomes lower compared to the state in which the pressure reducing valve 62 is closed. In this case, the aperture 541 is released, and thus the CNG in the first room 511 of the housing chamber 51 can be supplied through the downstream passage 54 into the delivery pipe 24. Accordingly, the fuel pressure in the delivery pipe 24 can be increased in an appropriate manner.

(6) The outflow passage 64 is connected to the downstream passage 54. In this configuration, when the pressure reducing valve 62 is opened, the CNG flowing from the second room 512 of the housing chamber 51 into the pressure regulating chamber 61 can also be supplied into the delivery pipe 24.

(7) The pressure of the high-pressure CNG supplied from the CNG tank 21 is reduced to the specified pressure by the first pressure reducing mechanism 40, and thereafter is introduced into the housing chamber 51. In this case, the high-pressure CNG is prevented from being supplied into the housing chamber 51. Accordingly, it is possible to enhance accuracy of regulation of the fuel pressure in the delivery pipe 24 performed by the second pressure reducing mechanism 50.

The above embodiment may be changed in the following manner.

A spring having a large diameter may be employed as the third spring 73, such that the lower end of the third spring 73 is located radially outward of the edge portion of the piezo-electric device 72. In this case, the third spring 73 directly urges the diaphragm substrate 70. Since the lower end of the third spring 73 is located radially outward of the contact portion between the diaphragm substrate 70 and the valve seat 74, an equivalent advantageous effect as that in (4) can be attained.

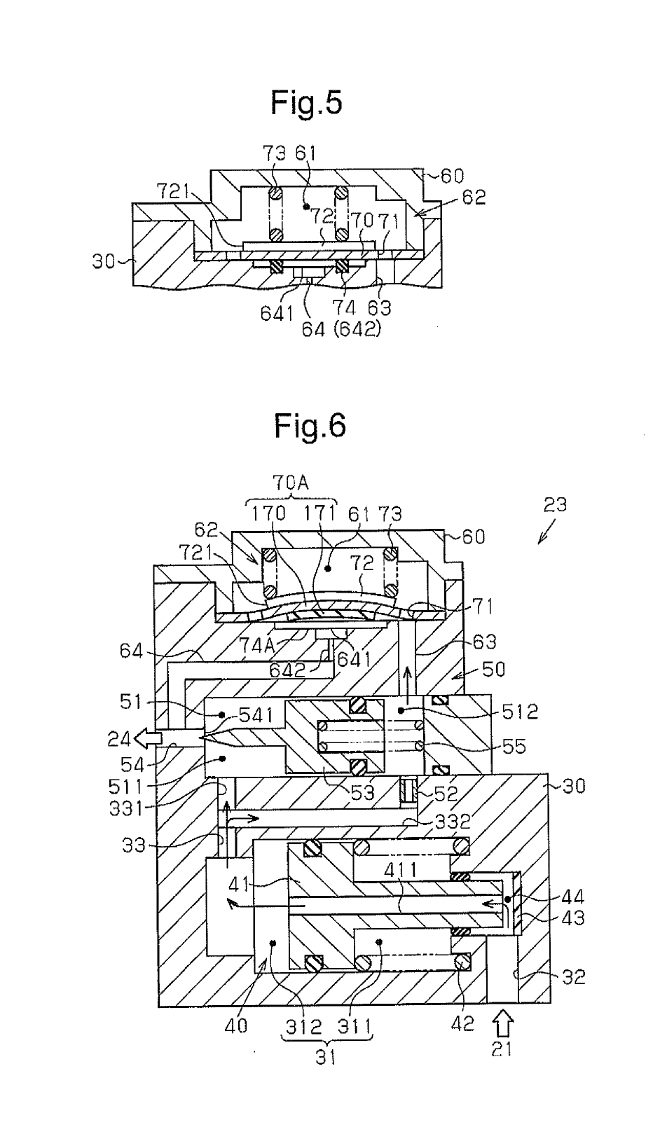

As shown in FIG. 5, the lower end of the third spring 73 may be located at the same radial position as the contact portion between the diaphragm substrate 70 and the valve seat 74. In this case, the third spring 73 can effectively urge the contact portion between the diaphragm substrate 70 and the valve seat 74. Accordingly, it is possible to improve tight contact between the diaphragm substrate 70 and the valve seat 74 while the piezo-electric device 72 is out of operation.

A component other than the piezo-electric device 72 may be employed as an actuator. For example, the valve body may be formed of a bimetal of two metallic plates having different coefficients of thermal expansion, and a Peltier element may be used as an actuator. In this case, the Peltier element may be used for adjusting a temperature of the bimetal to deform the bimetal.

A pressure reducing valve having a different configuration from that of the pressure reducing valve 62 may be used as the pressure regulating device 23 as far as a valve of this pressure reducing valve can be opened or closed through driving of the actuator. In this case, an equivalent advantageous effect as that in (5) can be attained.

As shown in FIG. 6, a valve body 70A, which is deformed through driving of the piezo-electric device 72 as an actuator, may include a diaphragm substrate 170 formed of a metallic plate or a ceramic plate, and a seal member 171 formed of a rubber material. In this case, the seal member 171 is preferably arranged on the surface of the diaphragm substrate 170 that faces a valve seat 74A. In this configuration, the piezo-electric device 72 is driven to deform the diaphragm substrate 170 and the seal member 171, thereby allowing the CNG in the pressure regulating chamber 61 to flow out into the outflow passage 64.

The pressure reducing valve may be configured in such a manner that the valve body is displaced in the direction of moving apart from the valve seat through driving of the actuator.

The pressure regulating device 23 may be used for equipment of a supply system for supplying gas, such as air, or liquid, such as water, other than a supply system for supplying a gaseous fuel such as CNG.

If a fluid to be supplied to the pressure regulating device 23 does not have so high pressure, the first pressure reducing mechanism 40 may be omitted.

1. A pressure reducing valve comprising:
a pressure regulating chamber;
a valve body arranged in the pressure regulating chamber;
an actuator that deforms the valve body; and
a valve seat on which the valve body is seated,
the pressure reducing valve configured such that
an inflow passage through which a fluid flows into the pressure regulating chamber, and an outflow passage to which the fluid flows out from the pressure regulating chamber are in communication with the pressure regulating chamber, and
a gap is formed between the valve body and the valve seat when the valve body is deformed through driving of the actuator to allow the fluid in the pressure regulating chamber to flow out to the outflow passage,
wherein a portion of the valve seat that faces the valve body is formed of an elastic material, and has a greater elastic force than that of the valve body.

2. The pressure reducing valve according to claim 1, wherein
the valve seat has an annular shape,
the outflow passage opens inward of the valve seat in the pressure regulating chamber,
a portion having a smallest diameter of the outflow passage is a small-diameter portion, and
an inner diameter of the valve seat is greater that the diameter of the small-diameter portion.

3. The pressure reducing valve according to claim 2, wherein
an urging member that urges the valve body against the valve seat is arranged on a side of the valve body that is opposite to the valve seat,
the valve body has a portion where urging force is applied from the urging member, and
the portion is located radially outward of a contact portion between the valve body and the valve seat.

4. The pressure reducing valve according to claim 1, wherein
an urging member that urges the valve body against the valve seat is arranged on a side of the valve body that is opposite to the valve seat,
the valve body has a portion where urging force is applied from the urging member, and
the portion is located at a same radial position as a contact portion between the valve body and the valve seat.

5. A pressure regulating device comprising:
a housing chamber; and
a downstream passage opening toward the housing chamber,
the pressure regulating device regulating outflow rate of a fluid, which has flowed in the housing chamber, flowing out through the downstream passage,
wherein
the pressure regulating device comprises a valve sliding in the housing chamber along a peripheral wall of the housing chamber,
the housing chamber is partitioned by the valve into a first room in communication with the downstream passage and a second room out of communication with the downstream passage,
a first upstream passage that introduces the fluid into the first room is in communication with the first room,
a second upstream passage that introduces the fluid into the second room is in communication with the second room,
an orifice is arranged in the second upstream passage, and
an inflow passage that introduces the fluid in the second room into the pressure reducing valve for regulation according to claim 1 is connected to the second room.

6. The pressure regulating device according to claim 5, wherein the outflow passage is in communication with the downstream passage.

7. The pressure regulating device according to claim 5, further comprising
a pressure reducing valve for high pressure that reduces pressure of a high-pressure fluid externally supplied,
wherein the fluid of which pressure is reduced by the pressure reducing valve for high pressure is supplied to the first upstream passage and the second upstream passage, respectively.

8. The pressure reducing valve according to claim 1, wherein the valve body is formed of a single plate member, and the actuator is a piezo-electric device.

9. The pressure regulating device according to claim 5, wherein the housing chamber is arranged with an aperture that communicates between the downstream passage and the housing chamber, and an urging member for a valve that urges the valve in a direction of sealing the aperture is arranged in the housing chamber.

10. A pressure regulating device comprising:
a housing chamber; and
a downstream passage opening toward the housing chamber,
the pressure regulating device regulating outflow rate of a fluid, which has flowed in the housing chamber, flowing out through the downstream passage,
wherein
the pressure regulating device comprises a valve sliding in the housing chamber along a peripheral wall of the housing chamber,
the housing chamber is partitioned by the valve into a first room in communication with the downstream passage and a second room out of communication with the downstream passage,
a first upstream passage that introduces the fluid into the first room is in communication with the first room,
a second upstream passage that introduces the fluid into the second room is in communication with the second room,
an orifice is arranged in the second upstream passage,
an inflow passage that introduces the fluid in the second room into the pressure reducing valve for regulation according to claim 1 is connected to the second room,
the pressure reducing valve for regulation comprises a valve body, and an actuator driven to deform or displace the valve body, and
the pressure reducing valve for regulation regulates outflow rate of the fluid flowing out from the pressure reducing valve for regulation.
